(19) United States
(12) Patent Application Publication
(10) Pub. No.: US 2021/0004901 A1
(43) Pub. Date: Jan. 7, 2021

(54) National Ticket Trading Index

(71) Applicant: Carl Ray Singleton, Lancaster, TX (US)

(72) Inventor: Carl Ray Singleton, Lancaster, TX (US)

(21) Appl. No.: 16/907,160

(22) Filed: Jun. 19, 2020

Related U.S. Application Data
(60) Provisional application No. 62/863,873, filed on Jun. 20, 2019.

(51) Int. Cl. G06Q 40/04; G06Q 20/04; G06Q 30/00; G06Q 20/12; G06Q 50/00; G06Q 10/02

(52) U.S. Cl. CPC G06Q 40/04; G06Q 20/0457; G06Q 10/02; G06Q 20/1235; G06Q 50/01; G06Q 30/0185

(57) ABSTRACT

Often, ticket brokers exploit fans. With transaction fees as much as 35% and substantial ticket markups by this $15.1 billion-dollar industry, fans face an enormous challenge when purchasing tickets to sporting events using this avenue referred to as the “secondary ticket market”. Far too long have fans waited for a level playing field in respects to purchasing tickets. Due to their greed; brokers, scalpers, and corporate exchangers have suppressed many fans' desires to attend the most popular sporting events. I have created a new ticket exchange concept that rewards fans for being fans and will not compromise the leagues profitability. This new concept will pioneer a more enthusiastic fan base that desires the in-game experience.

### I. SUMMARY

### National ticket Trading Index (NTTI)

The NTT Index number represents ticket trading frequency and this vitality or lack of will help leagues when establishing initial face value of tickets for similar future events. The cost of sporting events would more accurately be driven by true market value and under league control not broker control. The current broker driven state for ticket pricing and availability rob the various leagues and associations of revenue and places an undue burden on potential patrons when seeking tickets. This relatively small ticket broker community has a stranglehold on the ticket distribution industry by driving up cost through speculation and limited availability. Carefully disguised as supply and demand marketing, the ticket brokers through their unlimited buying power artificially raise prices by acquiring all available tickets. The customer is left with no other option than to purchase tickets utilizing a broker. Under league/association control ticket availability and pricing will reflect a spirit of merchant integrity, which will lead to greater consumer confidence. Plus, a true home field advantage may return to some teams in markets where ticket availability and pricing are impractical for the average fan. The financial benefits of having a universal sporting events ticket trading network:

Significantly cripples the illegal ticket sales industry.

Promotes fair market pricing without reducing profitability.

By not pricing them out, secures the in-game experience for the average fan.

Each league/association will directly benefit from any increase in ticket value based on market demands.

Brokers will no longer control ticket availability and pricing.

Increased web-based advertising by licensed league partners and other local/regional businesses. The leagues more favorable public perception will help toward generationally popularizing any sport.

### II. INTRODUCTION

This new 23 Hour sporting event online ticket trading market aspire to be affiliated with the following leagues and associations:

NFL

NBA

WNBA

MLB

NHL

MLS

UFC

ATP

WWE

IBF

PGA

LPGA

FIFA

WTA

IOC

NCAA

NASCAR

By implementing a more fair and equable ticket purchasing method you will create new fan enthusiasm that could sufficiently grow your customer base. Moreover, all customers will have an opportunity to purchase and trade on a level that affords them chances to attend sporting events never imagined. This business model rewards the fan for being a fan without compromising profitability. The revitalization of the in-game experience is needed and through this creative approach we will meet our goal. The option to attend a live sporting event rather than watching one on TV will truly be a viable option, again. One may say, there are other ticket exchanges. What's the difference? The NTTI is established to promote fan enthusiasm towards the in-game experience. The secondary resale ticket market is driven by a profit margin that threatens the attendance of the average fan. Attendance should not be a dream but a desire. These secondary markets champion no scalper zones and no hidden fees, but through neglect or ineptness they fail to keep ticket cost affordable. The cost to attend live sporting events has grown faster than the desire to attend these same sporting events. Why? The secondary markets have inflated cost beyond many customers' reach, which fleeces league profits and robs customers of the in-game experience. A favorable ‘technology adoption life cycle’ is the desire for the ticket industry and as a fan I have faith in our ability to embrace this new concept.

### III. NEEDS/PROBLEMS

Let's identify some needs or problems to be addressed with the secondary ticket resale market:

Problem: Resale prices often exceed face value.

Need: Peace of mind with verified tickets.

Problem: No guarantees and/or limited or no return policy.

Need: Provide insight on price movements.

Problem: Brokers price gouging fans.

### IV. GOALS/OBJECTIVES

Our desired goals and objectives to address the needs/problems stated above are as follow:

Objective: Acquire tickets from true fans, not scalpers.

Goal: All sales/trades brokered through leagues not the secondary markets.

Objective: Reliable fraud protection.

Goal: Generate fan enthusiasm for the in-game experience.

### V. PROCEDURES/COPE OF WORK

Resources Needed:

Approximately eleven relational databases with real time updates (AND/OR) an algorithm weighing the eight variables that will affect the cost of a ticket:

Thirty-three-system analysts

Web Hosting

Website Designer

Online Advertising

Terms and Conditions of Accounts

Loss Prevention and Fraud Protection Team

Authorization from leagues and associations to retrieve, store, and share their statistical data

### VI. TIMETABLE

Expected timetable for this project phases, and schedule for each phase.

Phase One

Description of Work: Introduce trading Index to participating leagues/associations.

Duration in Days: 60

Phase Two

Description of Work: Test and debug system mechanics with potential customers.

Duration in Day: 150

Phase Three

Description of Work: Secure potential advertisers.

Duration in Days: 60

Phase Four

Description of Work: Develop and train staff to setup, monitor, and maintain system.

Duration in Days: 75

Phase Five

Description of Work: Launch concept with a countdown campaign that includes instructions and information about establishing accounts and building portfolios.

Duration in Days: 45

### VII. BUDGET

Proposed costs and budget for this project. A centralized governing body will have budget oversight.

Phase One

Description of Work: Initial Marketing of this New Concept

Anticipated Cost: $20000.00

Phase Two

Description of Work: Research and Development

Anticipated Cost: $2100000.00

Phase Three

Description of Work: Secure Advertising

Anticipated Cost: $20000.00

Phase Four

Description of Work: Develop and Train Staff

Anticipated Cost: $2100000.00

Phase Five

Description of Work: Launch Product Event

Anticipated Cost: $1000000.00

Total: $5,240,000.00

### VIII. NEXT STEPS

### How it Works

Tickets will be purchased and traded at face value and/or adjusted index value online via a secure membership network. The trading hours will be from 1:00 am to 12:00 am central time. One hour per day will be reserved for scheduled routine network maintenance. Account Limits: (one account per person/corporation).

Account Types: Individual (AND) Corporate

### No Ticket Brokers Allowed

All accounts must be initially setup by customer online via a secure website using a computer or smart phone. During this initial setup an empty portfolio will be created and through online purchases and trades of tickets their portfolio will populate.

$2.99 to open an account

$2.99 per purchase/trade

Purchase Options

Multiple purchases limited to: 2, 4, 6, & 8 tickets per event depending on cost.

Limits When Purchasing Tickets from Leagues/Associations:

No. of Tickets Allowed per Price Range

8=$0-75

6>$75-150

4>$150-300

2 22 $300

Daily limits for individual accounts will be determined by the league/associations. Corporate accounts limit for purchasing tickets per event will be determined by the leagues/associations. Only licensed business partners can hold these corporate accounts and they are allowed to purchase/trade at ticket face value (not adjusted index value) only.

For customers who don't have access to a computer and/or smart phone, a toll-free phone number will be designated for purchasing tickets. Plus, if the customer has a portfolio account, the phone purchase can be added to their portfolio, when desired. Customers will still have an opportunity to purchase tickets from the box office(s) at various sporting venues in their local area.

Trades Must be Equal in Value

Example:

Trades must be equal in value: Face value+adjusted Index Value=Face value+adjusted Index Value

Face value=Face value (corporate account, only)

### NEXT STEPS CONT.

Multiples Allowed

Example:

(2) $75 tickets=(1) $150 ticket

(3) $25 tickets=(2) $37.50 tickets

Cross league trades are allowed at no additional cost and are limited to two leagues/associations per transaction.

Example:

(3) $15 MLB tickets for (1) $45 NBA ticket

(1) $300 NFL ticket for (2) $150 NASCAR tickets

Entire portfolios can be switched for $99.00 even if the values are not equal. Account holders can group their favorite trading partners, group chat, and setup group alerts. After face value of ticket is established, the trading frequency could increase/decrease the value of the ticket. Due to trading variables tickets in an Individual account portfolio can increase/decrease in value. Tickets in a corporate account portfolio will not increase/decrease because they can only be traded at face value.

After face value of ticket is established, certain trade variables could increase/decrease the value of the ticket. Ticket value will never fall below 25% of the face value, however; after positive variables a ticket value could increase 25% above face value.

### *Weighted Trade Factors: See FIG. ‘1A’

Intellectual Property

All data generated from the TT Index is the sole property of the exchange firm and could be sold to various gaming outlets such as casinos and fantasy leagues. If sold, the proceeds from these sells will be distributed evenly among the respective leagues.

### NEXT STEPS CONT.

Example:

If adverse weather conditions occur or elevate and no other variables are affected, the price could change as much as +/−4%. $100=$104 (or) $100=$96

Network Security

There will be security measures taken to ensure the network is safe for traders and to police fraudulent activity by unauthorized users disguised as individual or corporate traders.

Trade variables will be stored in an algorithm and/or within relational databases. The security and efficiency of the data coupled with the integrity of the network will determine which method of compiling, configuring, and warehousing these variables.

FRAUD Prevention

To minimize ticket scalping, initially only 12.5% of tickets per event will be available for nonportfolio

established customers. In municipalities where broker influence is insufficient this non-portfolio ticket availability percentage could increase.

Index Rate

The Ticket Trading Index will rise by 0.000001 each time a trade is completed and will fall by 0.000001 each time there are no trades completed network wide for one minute.

Buyer's Features at Time of Purchase:

Forecasted Weather conditions on event date

Trading Trends for specific event Team Injury reports

Prepay Parking option*

Concession Vouchers*

*(Allowed to be traded at face value, only).

League/Association Featured Options and Benefits:

Limited buy back of individual and corporate account holders' unwanted tickets at face value only. Bought back tickets can be place back in the trading network or sold directly from the box office. These newly acquired tickets can now be sold at the adjusted index value, if desired by the league/association. Bought back tickets can be designated to ‘Will Call’. By maximizing ticket availability, the leagues/associations will reduce ‘No Show’ rates. Possible tax incentive when compelled to sale below market value or donate tickets.

### NEXT STEPS CONT.

Tickets in some markets are often available on the secondary market below the season ticket holder's price; teams have to enhance the perks for season ticket holders via food discounts, club venues and special invitation-only events to maintain an incentive for the season ticket commitment. The price stabilizing nature of this new ticket exchange concept will resolve this phenomenon. After season ticket holders have been accounted for, leagues must be cautious when strategically releasing tickets to maximize availability and event enthusiasm. This could cause ticket prices to spike or fail too rapidly creating market instability. This ticket exchange system allows for market flexibility, but the cost for any ticket will never drop below the initial face value.

Ticket Redemption

If not redeemed, tickets in an account holder's portfolio will expire at the commencement of the sporting event. All trading and league/association buy back activity will cease once the sporting event starts and all tickets must be redeemed or they will soon expire. Ticket holders will have an optional alert to inform them when sporting events are starting soon. At this time, they may have an opportunity to make a final ticket trade or sell back to the league/association. NOTE: Once redeemed, a ticket cannot be traded. However, prior to start of sporting event redeemed tickets purchased at a box office or online can be sold back to the leagues/associations.

Online Purchases

After acquiring ticket(s) through purchase/trade, customers have the option to print and/or store ticket(s) electronically. Both printed and electronically stored tickets can be presented for entry to all sporting events. By choosing to redeem ticket(s) removes it from the customer's trading portfolio. Re careful not to prematurely redeem tickets.

Box Office Purchases

Even if purchased at box office/sporting venue prior to the day of the event, the tickets will be labeled as redeemed and these tickets can only be returned/traded at the box office/sporting venue where they were originally purchased. Box office/sports venues must be equipped to print specialty marked ticket receipts which customers will present to enter event. At the end of any purchase customer will have an opportunity and will be encouraged to flag the ticket(s) for identity verification when entering the specified sporting event.

Trading Integrity

If leagues/associations determine through reasonable cause that any customer is unfairly trading such as but the limited to a broker, the customer's account may be suspended until further investigation. Broker accounts will be terminated and the tickets within their portfolios will be refunded at face value. Fraudulent activity could result in the leagues taking legal action toward perpetrators.

Estimated Daily Revenue Generated from Trade Activity

Number of Sporting Events: 1000 Trading Frequency: 250 per hour Estimated Revenue: $34,385.00 per day (Excluding actual ticket price)

Number of Sporting Events: 1000 Trading Frequency: 500 per hour

Estimated Revenue: $68,770.00 per day (Excluding actual ticket price)

### *National Ticket Trading Index Chart: See FIG. ‘1B’

| | | | |
|---|---|---|---|
| League/ | No. of | Trading | Estimated |
| Association | Scheduled Events | Frequency | Revenue per day |

Team Sports

| | | | |
|---|---|---|---|
| NFL | 256 | 128 | $17,605.12 |
| MLB | 2430 | 1215 | $167,111.10 |
| NCAA | 10000 | 5000 | $687,700.00 |
| WNBA | 204 | 102 | $14,029.08 |
| NBA | 1230 | 615 | $84,587.10 |
| NHL | 1271 | 635.5 | $87,406.67 |
| MLS | 374 | 187 | $25,719.98 |
| Daily Total | 15765 | 7882.5 | $1,084,159.05 |

Individual Sports

| | | | |
|---|---|---|---|
| IBF | 30 | 15 | $2,063.10 |
| UFC | 20 | 10 | $1,375.40 |
| WTA | 20 | 10 | $1,375.40 |
| PGA | 50 | 25 | $3,438.50 |
| ATP | 20 | 10 | $1,375.40 |
| LPGA | 20 | 10 | $1,375.40 |
| NASCAR | 20 | 10 | $1,375.40 |
| IOC | 20 | 10 | $1,375.40 |
| WWE | 20 | 10 | $1,375.40 |
| Daily Total | 220 | 110 | $15,129.40 |

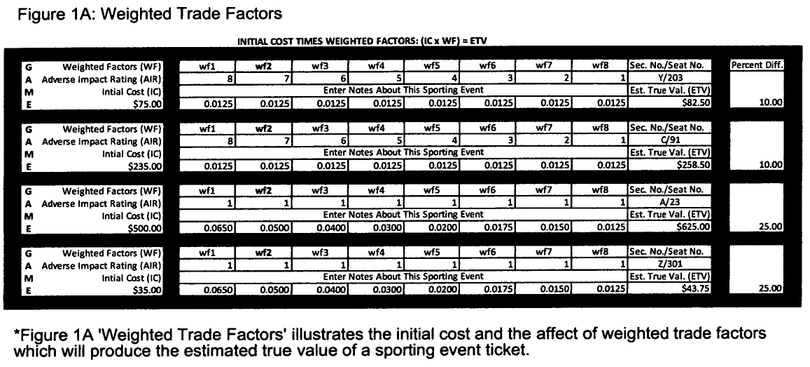

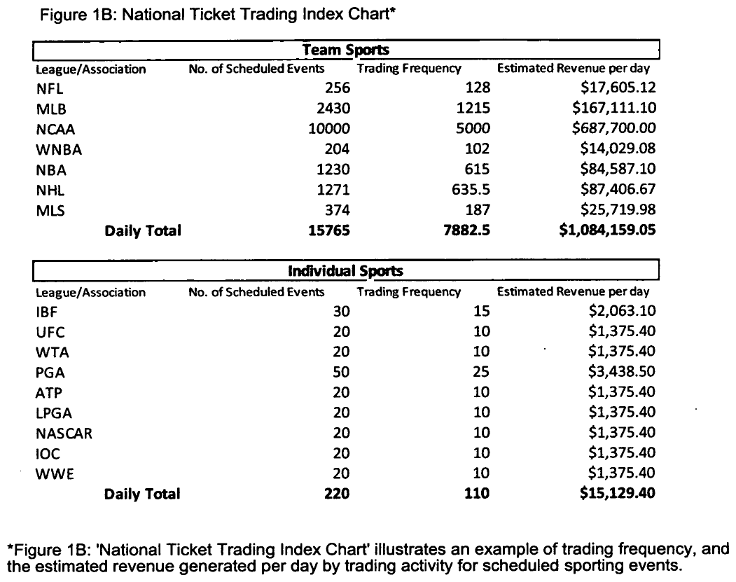

NOTE:
Estimated Revenue Generated Above Does Not Include Initial Ticket Price.
*FIG. 1B: ‘National Ticket Trading Index Chart’ illustrates an example of trading frequency, and the estimated revenue generated per day by trading activity for scheduled sporting events.

### IX. APPENDIX

Frequently Asked Questions

Q. Will this new system limit ticket solicitation at venues where ticket scalping is legal?

A. When tickets are purchased at a box office and/or venue in a location where scalping is legal the buyer's full name appears on the ticket and a photo id is required when presenting tickets for event entry.

Q. How to prevent brokers and/or scalpers from buying up the remaining tickets at the box office?

A. If purchasing at a box office and/or venue, four tickets maximum will be sold per customer per event.

Q. What about counterfeit tickets?

A. All box office/venue printed tickets will have watermarks and other non-duplicating fraud protection features.

Q. What discounts are accepted online?

A. All league/association approved promotional discount codes will be honored within the NTTI website for various ticket purchases.

Q. Can less than 12.5% of tickets per event be sold through non-portfolio means?

A. Yes, league/association will govern the percentage of ticket availability.

Q. How will the leagues/associations profit from this system?

A. They will maintain control over all ticket availability and pricing subsequently putting an end to the secondary ticket resale market.

Q. Will season ticket holders have an opportunity to trade on the NTTI Network?

A. Yes, season ticket holders are allowed to setup individual accounts and trade their season ticket(s). NOTE: At initial face value, only.

### List of Secondary Ticket Markets

2 Ticket GuysAlchemistix

Avery Tickets

Uberseat

303ticketconnect.com

Alliance Tickets

Bakersan Ticket Service

Ultimate Ticket Shop

A Great Place to Sit

ABC Tickets

AmpTix

Asc Ticket

Big Dog Tickets

Bly Ticket Group

Up Close Ticket Source

Valley of the Sun

Admit One

Atlas Tickets

Boulder Tickets

Viagogo

Brock's Tickets

Cali Tickets

Charm City Tickets

Club House Tickets

Colorado Ticket Service

Craigslist Tickets

CRTTickets

dealnology

Denver Ticket

Dolly's Tickets

Down in Front

dream team tickets

DreamTix

Dynamic Tickets

Easy Seat

EbayEmpire Tickets

Epic Seats

Erics Events

EventUsa

Fanatic Fan Tix

Fanboy Tickets

Fanxchange

Free Ticket Exchange

Full Action Tickets

Get Tix

Glory Days Tickets

GoTickets

Gottixx

Greystone Tickets

Hammer SportsHawkstixx

Headline Tickets Now

Hotline Entertainment

I need a miracle

I Want Great Seats

I Want My Tickets

iconcerttickets

In Seats

Internet Tickets Outlet

INVIGORatix

Lante Tickets

Little Larry's Tickets

Lookup Tickets

Lowdown Tickets

Lower Level Tickets

Magic City Tickets

MavCowTickets

Minnetonka Tickets

mnticketking

Momentum Tickets

Mr Ticket King

MyTicketDude.com

### APPENDIX CONT.

Pick A Ticket

Pick A Ticket Entertainment LLC

Pittsburgh Ticket Company

Porkys Tickets

Prime Sports

Prime Ticket Service

Prime Time Stubs

Primesport

Quality Ticket Deals

Razorgator

ReadyNowTickets

Red Stick Tickets

Red Zone Tickets

RocketPoster test

SeatHippoSeats Up Front

Sell Ticket Service

shytowntickets

Sling Tickets

Small World Tickets

SocialChair

Southeastern Tickets

Star One Tickets

StubHub

Stubmenu

Super Fan Tickets

Super Seats USA

Super Star Tickets

Supreme SeatsThe Ticket Woman

Ticket Champ

Tickct Man

Ticket Network

Ticket Yard

TicketCapo

Ticketcity

TicketFish.com

TicketKing

TicketMann

TicketNix

TicketProxy

Tickets 2 All USA

Tickets Canada

Tickets Deluxe

Tickets.ca

Tickets321.com

Ticketsnow

TicketsRus

Ticketstumbler

Tix International

Tixburgh

TN Direct

Total Travel and Tickets

VIP Seats

### APPENDIX CONT.

vip tickets

VIP Tickets VegasVlPTicketPlace

Vivid Seats

WanaMaker Tickets

William Penn Tickets

Worldwide Tickets

YourTicketCentral

Through the diligence of research and the frustration of getting priced out of major sporting events, I have developed a new ticket exchange concept. This new concept will address five concerns:
the league's profit lost from ticket sells when tickets are virtually distributed through the secondary markets
lack of ticket availability
unbridled ticket cost increases
a growing indifference to the in-game experience
illegal ticket reproduction

If implemented, the new concept will enhance league profitability, and maximize consumer choice.

1. I claim this ticket exchange system will eliminates secondary ticket market influence over sporting event industry.

2. I claim this ticket exchange system will leagues, commissions, associations, and federations will have control of ticket distribution.

3. I claim this ticket exchange system will leagues, commissions, associations, and federations can set the initial cost of a sporting event ticket.

4. I claim this ticket exchange system will fan will control the ticket market price fluctuation.

5. I claim this ticket exchange system will exchange system has built in counterfeit safeguards.

1. I claim this ticket exchange system will the weighed factors used in the algorithm could realistically influence the cost of a sporting event based on independent claim (1).

2. I claim this ticket exchange system will purchasing limits helps maintain ticket availability based on independent claim (2).

3. I claim this ticket exchange system will broadens fan base due to lower ticket costs based on independent claim (3).

4. I claim this ticket exchange system will fan trade activity increases revenue for leagues, commissions, associations, and federations based on independent claim (4).

5. I claim this ticket exchange system will membership requirement reduces fraudulent ticket exchanges based on independent claim (5).
